(19) United States
(12) Patent Application Publication
(10) Pub. No.: US 2015/0168302 A1
(43) Pub. Date: Jun. 18, 2015

(54) DENSITY ANALYSIS OF LIVING ORGANISMS BY MAGNETIC LEVITATION

(71) Applicants: John Matthew Dubach, Somerville, MA (US); Heather A. Clark, Lexington, MA (US)

(72) Inventors: John Matthew Dubach, Somerville, MA (US); Heather A. Clark, Lexington, MA (US)

(73) Assignee: NORTHEASTERN UNIVERSITY, Boston, MA (US)

(21) Appl. No.: 14/239,401

(22) PCT Filed: Aug. 22, 2012
(86) PCT No.: PCT/US12/51811

§ 371 Date: Oct. 2, 2014

Related U.S. Application Data
(60) Provisional application No. 61/525,919, filed on Aug. 22, 2011.

(51) Int. Cl. G01N 21/64

(52) U.S. Cl. CPC G01N 21/6486; G01N 21/6456; G01N 2201/062; G01N 2201/068

(57) ABSTRACT

A system and method enabling a portable electronic device to perform fluorescent measurements are provided. The system can comprise a case that houses one or more Light Emitting Diodes and an optical filter. The system can further comprise a push button, a microcontroller and a power source. The system can cause excitation of fluorescent molecules in environmental, biological, and chemical samples, as well as in fluorescent molecules located in or on a tissue of an organism. The disclosed methods and systems also allow for the capture of images of fluorescence through the portable electronic device.

### CROSS REFERENCE TO RELATED APPLICATIONS

This application claims the benefit of U.S. Provisional Application No. 61/525,919, filed Aug. 22, 2011, the entire contents of which are hereby incorporated by reference herein.

### STATEMENT REGARDING FEDERALLY SPONSORED RESEARCH/DEVELOPMENT

This research was funded by grants from the National Science Foundation, Grant DGE-0504331 and DARPA, Grant ARMY/W911NF-11-1-0025.

### FIELD OF THE INVENTION

The invention is generally directed to methods of analyzing and separating complex samples. Specifically, the invention is directed to methods of analyzing organisms in biological samples.

### BACKGROUND OF THE INVENTION

Fluorescence-based detection assays are an important component in biotechnology, analytical chemistry, analysis of environmental samples, and medical diagnostics. Fluorescence-based assays exhibit exceptional sensitivity, detecting small concentrations of fluorescent molecules. In addition, fluorescent detection assays are capable of providing detailed pictures of where fluorescent molecules are localized in tissues and cells. These procedures involve the use of a fluorometer, usually with a single exciting wavelength and single detection wavelength.

However, fluorometers can be quite expensive. For instance, inexpensive fluorometers cost at least $2,000. In certain instances, such equipment is not necessarily available (e.g., measurements performed outside of the laboratory) or warranted (e.g., when rapid measurements are desired).

In medical diagnostics, fluorescence detection offers a useful methodology to monitor concentrations of molecules such as proteins, electrolytes, and other molecules. However, most patients and doctors do not have immediate access to the equipment necessary to detect fluorescence. The reasons can be associated with the cost, the size, and the complexity of operating the equipment.

Identifying methods and systems to assay effectively electrolytes and other diagnostically important molecules is becoming more important as the world population ages and places strain on the healthcare system. FIG. 1 shows the projected population growth and long-term care spending for the U.S. Presently, there are numerous health indicators to monitor. However, glucose and blood pressure are the only targets that presently allow for widespread patient self-monitoring. Measurements of other physiological analytes typically require blood draws which prevents continuous monitoring of analytes. The ability to continuously monitor levels of analytes without requiring blood draws would allow for easy monitoring of physiological conditions. This control will enhance the health of patients. One solution to these issues is to provide patients and doctors with an easy, small, and cost-effective system for detection.

Therefore there is a need for a device and methods for the inexpensive and rapid assaying biological, environmental, and chemical samples. Furthermore, there remains a need for a device and methods for assaying samples from environmental and other samples.

### SUMMARY OF THE INVENTION

According to aspects of the present disclosure, a portable electronic device is provided that can be used as an instrument to assay environmental, biological, and chemical samples. Aspects of the invention also involve methods of measuring the fluorescence in a sample. Furthermore, the devices and methods disclosed herein provide for rapid and simple measurement of analytes in tissues, such as skin.

Aspects disclosed herein provide a method for performing fluorescent measurements using a portable electronic device utilizing at least one light emitting diode (“LED”) and an optical filter. The method comprises receiving an electrical stimulus at the at least one LED to activate the at least one LED and emitting by the at least one LED an excitation light. In addition, the method includes contacting one or more fluorescent sensors with the excitation light, the one or more fluorescent sensors emitting a fluorescent light when contacted with the excitation light and filtering by the optical filter such that a camera on the portable electronic device portable electronic captures an image of the fluorescent light emitted from the fluorescent sensors.

In certain embodiments, a microcontroller provides the electrical stimulus to the LED. In further embodiments, the fluorescent sensors comprise fluorescent dyes, chemical sensors, fluorescent proteins, nanoparticles, or combinations thereof. In still further embodiments, the fluorescent sensors are detected in skin, fluid samples, blood, bodily fluids, tissue samples, hair, and immunoassays. In certain embodiments, the method further comprises providing software to enable an interaction of the at least one LED, optical filter, and portable electronic device

In some embodiments, the at least one LED and the optical filter are located on a case adapted for attachment to the portable electronic device. In more particular embodiments, the case further comprises a microcontroller configured to provide electrical stimulus to the at least one LED.

In additional aspects, a device for enabling a portable electronic device to perform fluorescent measurements is disclosed. The device comprises a case adapted for attachment of the device to a portable electronic device, at least one light emitting diode, and an optical filter. In certain embodiments, the device further comprises a microcontroller. In some embodiments, the microcontroller is configured to operate the at least one LED.

In other embodiments, the optical filter is positioned such that the filter covers a lens of a camera on the portable electronic device when the case is attached to the portable electronic device. In particular embodiments, the case further comprises a power source. In further embodiments, the case comprises an optical chamber adapted to be positioned over a camera on the portable electronic device, the optical chamber comprising the at least one LED and the optical filter.

Aspects disclosed herein include a system for fluorescent measurement. The system comprises a case attached to a portable electronic device, the portable electronic device comprising a camera, a processor, and an interface, the case comprising at least one LED and an optical filter. In certain embodiments, the processor comprises logic to enable a user to activate the at least one LED. In other embodiments, the processor comprises logic to enable the user to capture an image using the camera.

In additional embodiments, the image comprises a fluorescent emission from a plurality of fluorescent sensors. In more embodiments, the processor comprises logic to measure the intensity of the fluorescent emission from the plurality of fluorescent sensors. In other embodiments, the processor comprises logic to enable the user to calculate an amount of an analyte based on the intensity of the fluorescent emission. In particular embodiments, the processor comprises logic to store the image in a memory on the portable electronic device.

In certain embodiments, the optical filter is positioned on the case to cover a lens on the portable electronic device. In more particular embodiments, the case further comprises a microcontroller. In some embodiments, the microcontroller is configured to operate the at least one LED.

In certain embodiments, the case comprises an optical chamber positioned over the camera on the portable electronic device, the optical chamber comprising the at least one LED and the optical filter.

In particular embodiments, the processor comprises logic to wirelessly transmit the image and any related information to another portable electronic device.

### DESCRIPTION OF THE FIGURES

The following figures are presented for the purpose of illustration only, and are not intended to be limiting:

FIG. 1 shows the projected population growth and long-term care spending for the U.S.

FIG. 2 shows a comparison of the size of the whole animal imager and the system according to aspects of the present disclosure.

FIG. 3 shows an example of a current clinical analyzer.

FIGS. 4 and 5 show exemplary methods of using the disclosed system.

FIGS. 6a-d show different views of an exemplary case according to aspects of the present disclosure.

FIG. 7 shows a prototype imaging case according to aspects of the present disclosure.

FIG. 8a shows light split into three channels by an RGB CMOS sensor. FIG. 8b shows the frequency response of the emitted LED light and the emission filter.

FIG. 9 shows images taken from a whole animal imager and the iPod prototype.

FIG. 10 shows three different sensors and a QR code.

FIG. 11 shows a method for shifting the calibration curve to fit adjustment points.

FIG. 12 shows an exemplary application interface.

FIG. 13 shows absorbance (A) and emission spectra of sodium sensors excited at 476 nm (B) and 640 nm (C).

FIG. 14 shows (A) measured ratio concentrations and (B) example image concentrations.

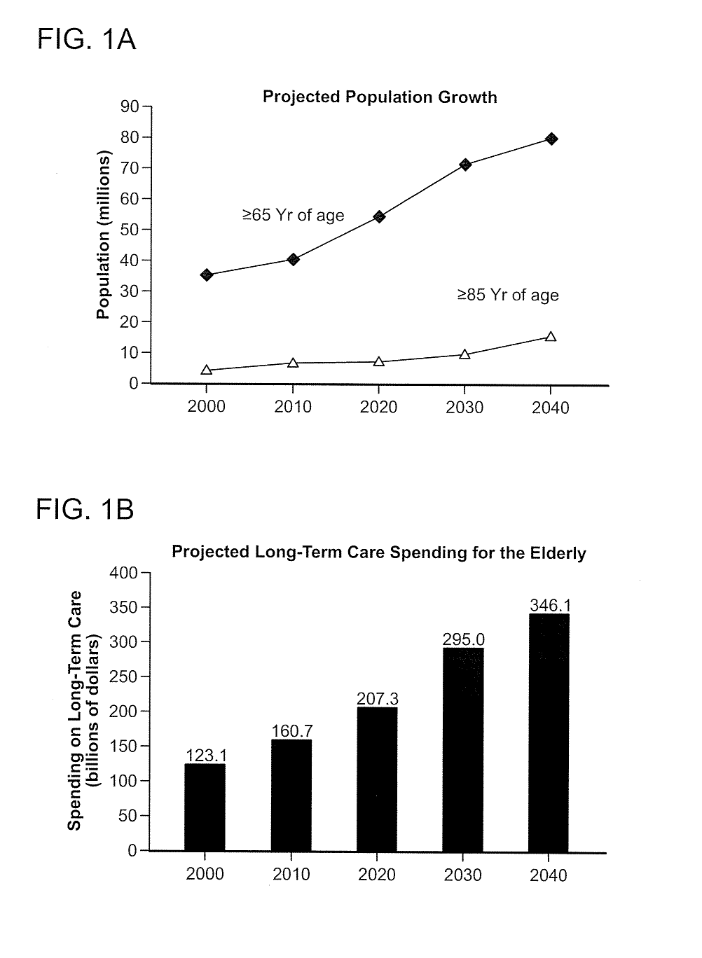

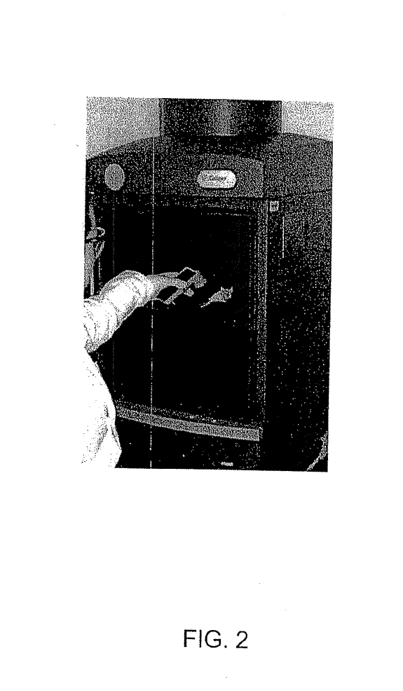

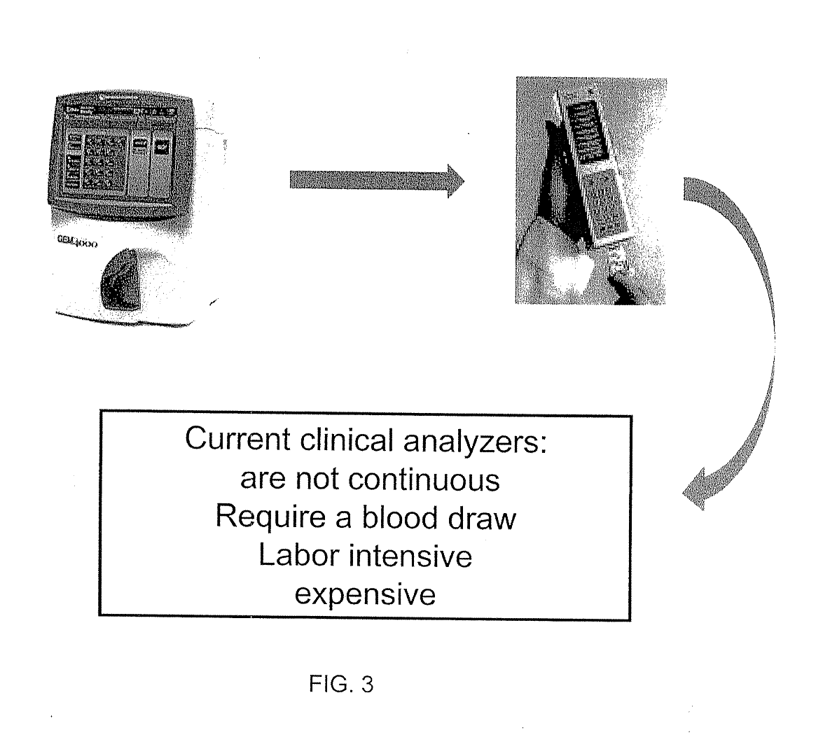

### DETAILED DESCRIPTION OF THE INVENTION

### 1. General

According to aspects of the present disclosure, a system for fluorescent measurement is provided. In particular embodiments, the system includes a case attached to a portable electronic device in which the portable electronic device comprises a camera, a processor, and an interface. Furthermore, the case comprises at least one LED and an optical filter. As used herein, the term “portable electronic device” means a device that stores, processes, or transmits information. Examples of portable electronic devices include but are not limited to smartphones, such as an iPhone, BlackBerry, and Android, cellular phones, personal digital assistants, and other such devices that include a user interface and the capability to capture and store an image (e.g., a camera). Another example of a portable electronic device is an iPod Touch. In some embodiments the portable electronic device includes a camera and/or a lens. In some embodiments a camera and/or a lens are not included in the portable electronic device, but are included in the device for enabling the portable electronic device to perform fluorescent measurements.

Embodiments of the system include a case and a portable electronic device that, in combination, act as a fluorometer for the measurement of fluorescence in a sample (e.g., a biological, chemical, or environmental). The portable electronic device has the additional function of capturing images of fluorescent sensors that have been excited by an excitation wavelength. This is accomplished by using a camera included with the portable electronic device. In addition, the portable electronic device comprises applications that allow for measurement of the intensity of the light emitted from the fluorescent sensors when they are exited by a wavelength of light.

As used herein, the term “fluorescent sensor” means a compound, device, nanoparticle, or substance that emits light when contacted by light or electromagnetic radiation. Such sensors can be excited by any wavelength of light between 400 nm to 800 nm. In certain embodiments, the excitation wavelength of light is between 450 nm to 700 nm.

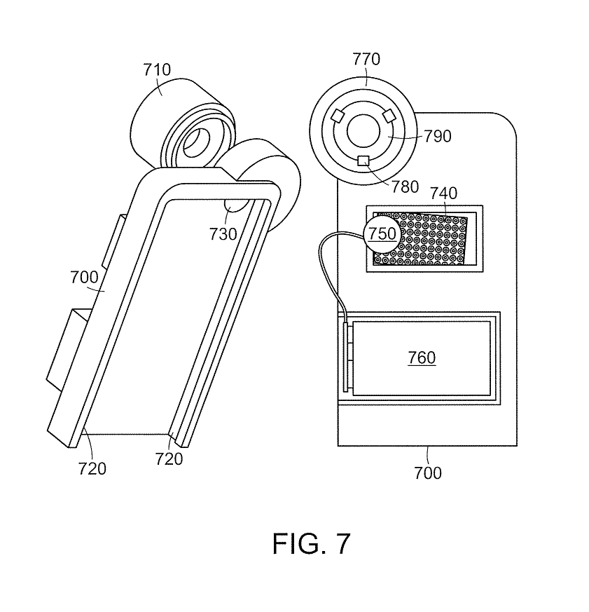

Regarding the case, it is capable of emitting an excitation wavelength of light through light emitting diodes (“LEDs”) positioned upon the outer surface of the case. As shown in FIG. 7, the LEDs are disposed on the case so as to allow the user to direct light emitted from the LED onto a sample (e.g., biological, chemical, or environmental) or in a tissue. The excitation wavelength emitted by the LEDs contacts at least one fluorescent sensor in a sample or in a tissue.

The case also has an optical filter positioned on it. In certain embodiments, the optical filter is a fluorescent filter that is designed to filter out the excitation wavelength emitted by the LEDs, thereby allowing the fluorescent light emitted from the fluorescent sensors to contact a lens of a camera on the portable electronic device without excitation light confounding the image. Fluorescent filters are known in the art and can be obtained commercially from suppliers Chroma Technology Corp (Bellows Falls, Vt.).

In certain embodiments, the optical filter is positioned on a chamber attached to the case. The chamber is attached to the case in such as manner to allow for the optical filter to be positioned over the lens of the camera on the portable electronic device. In this way, the optical filter allows fluorescent light from the sensors to illuminate the lens of the camera. In particular embodiments, the chamber is a box structure comprising an optical filter defining one surface of the chamber directly in front of the lens of the camera of the portable electronic device. Such chambers have four sides that do not allow light to be transmitted to the lens of the camera. Thus, the only light that contacts the lens of the camera is the fluorescent light emitted from the fluorescent sensors.

The case can be made of known materials and using known methodologies. The chamber can be made of the same materials used to make the case. It can be produced separately and attached to the case after the case has been produced. For instance, the case and/or chamber can be made of plastics such as polyethylene, polypropylene, polystyrene, and polyvinyl chloride. The case and/or chamber can also be made of metals such as aluminum, and metal alloys. The case and/or chamber can also be made of fiber glass.

The case can be constructed through rapid prototyping. For example, injection molding techniques can be used or any available techniques for building cases for portable electronic devices (see, e.g., Bryce. Plastic Injection Molding: Manufacturing Process Fundamentals. SME, 1996. pg. 43-44).

In additional embodiments, the case comprises an optional push button to activate and deactivate the LEDs. In some embodiments, the case comprises a microcontroller that operates the LEDs. The microcontroller can be an Arduino microcontroller. The case can also comprise a power source, such as a battery.

Alternative portable electronic devices could use a camera in the case that can transmit the images to the mobile phone for analysis. Also, the device can be powered by a smaller battery with a voltage gain or by the portable electronic device itself. Data and power transmission can alternatively occur though wire connecting the microcontroller to the portable electronic device.

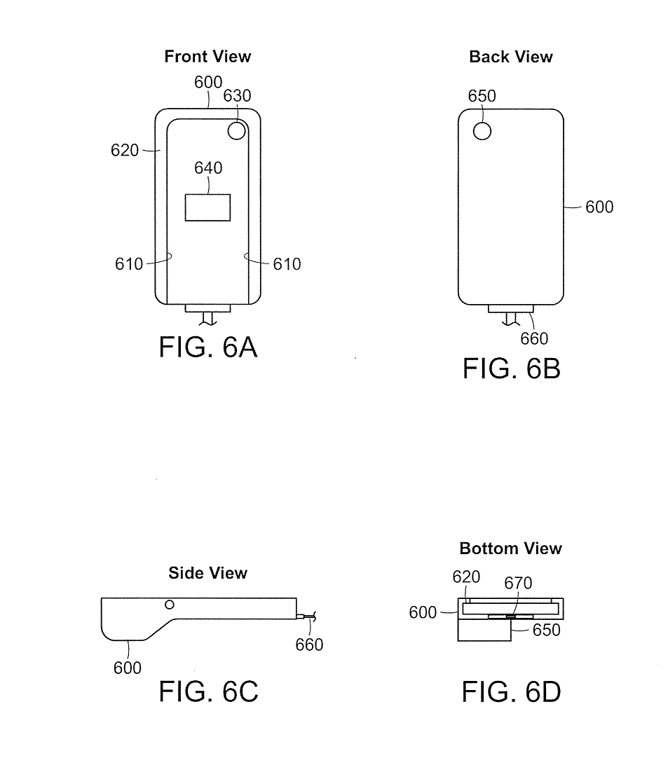

In the disclosed systems and methods, the case is adapted for attachment to a portable electronic device. Any mechanism can be used to attach the case to the portable electronic device. In certain embodiments, the case is attached to the portable electronic device so that the optical filter is positioned over the lens of the camera on the portable electronic device. The portable electronic device is allowed to slide along slots 610 in case 600 until it reaches a lip 620 (FIG. 6A). The portable electronic device is, thus, positioned in the case 600 to allow the optical filter 630 to cover a lens of a camera of the portable electronic device, while allowing the user to manipulate the portable electronic device using an interface on the portable electronic device. In certain embodiments, the case 600 also includes a plate to cover the microprocessor 640.

In other embodiments, the case comprises clips that allow for attachment to the portable electronic device. The clips grasp the portable electronic device and prevent the portable electronic device from moving with respect to the case. The clips can grasp the portable electronic device at any position so long as the case does not obstruct the user's operation of the device and the optical filter is positioned over the lens of the camera on the device.

As discussed above, the disclosed systems cause excitation of the fluorescent molecules and, in certain embodiments, capture images of the fluorescence through a camera of the portable electronic device. Therefore, the portable electronic device can be converted into a diagnostic or laboratory instrument by creating a system, according to aspects of the present disclosure, which sets up the proper imaging pathway and houses the necessary electronic and optical components. The system can be used to determine sensor response to sodium in vitro.

### 2. Applications

The disclosed systems and devices enable the use of a portable electronic device to make medical diagnostic or fluorescence measurements in environmental, chemical, or biological samples. In certain embodiments, environmental samples are obtained from water sources, both natural and man-made, waste, or from soil samples. In some embodiments, chemical samples include assays of chemical compounds in laboratory samples and from samples obtained from synthesis experiments. In other embodiments, biological samples include tissue or cell samples taken from a subject such as a mammal, microbial samples obtained from a surface or liquid, and samples grown in the lab.

In the embodiments described herein, the system allows a user to detect fluorescence using a novel methodology. In one embodiment, the user is able to activate the LEDs on the case attached to a portable electronic device. The user directs the LED light onto the sample or subject containing the labeled analytes or cells and allows the excitation light to contact the fluorescent sensors, which will emit fluorescent light when contacted with the excitation light. The user is able to view the fluorescent signal on her portable electronic device due to the filtering by the optical filter. If the user desires, she can capture an image on her portable electronic device by using its camera.

As described above, the disclosed systems convert a standard portable electronic device into a fluorescence imager. Therefore, the disclosed systems miniaturize current fluorescent imaging methods to make them more portable and potentially more cost effective. Furthermore, when coupled with fluorescent sensors, the disclosed system can measure, record and interpret medical or chemical data through software application running on the portable electronic device. The disclosed system can be used for medical diagnostics, chemical detection, or laboratory experiments.

Such measurements can be used to detect the amount of an analyte in a sample. As used herein, the term “analyte” means a substance that is being analyzed by a procedure such as fluorescent detection. Examples of analytes include electrolytes, proteins, nucleic acids, lipids, ions, and carbohydrates. However, this list should not be considered limiting because any substance that can be detected by fluorescent sensors known in the art is detectable using the present systems and methodologies. Techniques for staining analytes are known to those of ordinary skill in the art (Dubach(2007) Nano Lett 7(6) 1827, Jing (2011) Anal Chim Acta 686(1-2)9, Masi (2010) Adv Exp Med Biol 674:33).

In certain embodiments, the analyte is a nucleic acid molecule that has been stained with a fluorescent sensor. In these embodiments, the nucleic acids can either be in located in permeabilized cells where the nucleic acid has been stained with a sensor specific for nucleic acids or the nucleic acids have been isolated from the cells and stained. Fluorescent stains (i.e., fluorescent sensors) of nucleic acids are known in the art and include ethidium bromide, SYTO® green-fluorescent nucleic acid (Invitrogen Corp., Austin, Tex.), 4′,6-Diamidino-2-phenylindole dihydrochloride, 5(6)-Carboxy-X-rhodamine, 5(6)-Carboxyfluorescein, and fluorescent cyanine dyes produced by Amersham Pharmacia Biotech (Piscataway, N.J.). Techniques for the fluorescent modification of nucleic acids are described in, see, e.g., Chen (2000) J. Org Chem. 65:2900-2906: Chen (2000) J. Biochem. Biophys. Methods 42:137-151. See also U.S. Pat. Nos. 7,994,296; 6,060,324; 5,994,063; 5,614,386; 5,248,782; 5,227,487; and 5,187,288.

In other embodiments, the analyte is a protein that has been labeled with fluorescent sensors or has reacted with fluorescent sensors. The proteins can be stained in a PAGE gel and visualized using the systems and methods disclosed herein. Such proteins can be stained with fluorescent stains known in the art, including Thermo Scientific Krypton Fluorescent Protein Stain. In addition, proteins can be isolated from samples (e.g., tissue or environmental samples such as water or soil samples) and reacted with fluorescent sensors specific for proteins. Labeled proteins can also be immobilized prior to detection. The proteins can also be stained in fixed cells that have been permeabilized. Examples of protein-specific fluorescent dyes are rhodamine and fluorescein.

The systems and methods described herein are also useful in laboratory assays such as enzyme linked immunoassays (“ELISA”) that utilize fluorescently labeled antibodies or antibody fragments such as Fab fragments. There are a variety of commercially available kits for the labeling of antibodies such as Lightning-Link™, Allophycocyanin (APC)Lightning-Link™, B-Phycoerythrin (BPE)Lightning-Link™, and PerCPLightning-Link™ R-Phycoerythrin (RPE) (Innova Biosciences) and fluorescein-labeling (KPL, Inc., Gaithersburg, Md.).

Additionally, the systems and methods can be utilized to identify fluorescently labeled nucleic acids and proteins immobilized on a solid support such as a biochip, membrane, or other inert material. In such embodiments, the nucleic acids and proteins are labeled by techniques known in the art and immobilized using techniques described in Schena et. al., (1995) Science, 270(5235): 467-470; Lal et. al., (2002) DDT (Suppl.) 7(18): 5143-5149. Once the nucleic acids or proteins are immobilized on the support the fluorescence can be analyzed using the systems disclosed herein by simply activating the LEDs and directing the excitation light onto the support. Any fluorescence will be visible on the interface of the portable electronic device and the user will be able to capture the image and perform additional analysis.

Furthermore, lipids and fatty acids can be stained in a sample and visualized using the systems and methods disclosed herein. Lipids and fatty acids can be isolated from food, soil or water samples, as well as cell and tissue samples from a subject. One purpose for such an analysis is to determine whether there are microbes in the sample of interest. The presently disclosed methods and systems allow for rapid and easy identification of fluorescently labeled lipids in a sample. An exemplary lipid-specific fluorescent stain is Nile red. Lipid-staining techniques are well known in the art (see, e.g., Bonilla et al. (1987) J Histochem Cytochem. 35(5):619-21).

The systems are also capable of visualizing cells in a sample, such as cells in an environmental sample or a tissue sample, that have been stained with the fluorescent dyes described above. In certain embodiments, cellular components are labeled with fluorescent sensors after cells have been homogenized. In other embodiments, cellular components are labeled while the cell is intact; such fluorescent labeling of cells has been previously described in Butcher et al. (1980) Immunol Methods. 37(2):97-108.

Furthermore, user can identify the concentration of ions and other small molecules in a sample or subject. In certain embodiments, ions and small molecules are identified through the use of nanoparticles that can fluorescently report the presence of ions and small molecules. In these embodiments, the particles can be easily injected through either an insulin syringe or a needleless injection device.

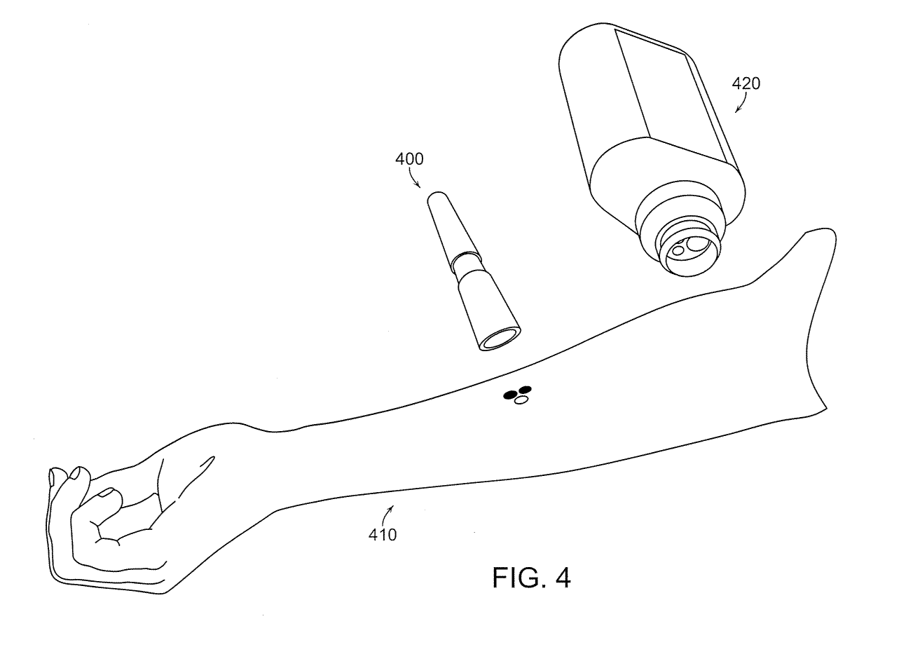

FIG. 4 shows an exemplary method of injection using a minimally invasive technique. Injector 400 injects a solution of sensors into the skin. Subcutaneous injection is well known in the art and any device that can be used by a physician or a subject to inject sensors into the skin. In certain embodiments, the sensors are fluorescent sensors described herein. The sensors are shown localized in a region 410 of skin of the subject. The sensors, in this embodiment, react with analytes such as glucose, sodium, chloride, electrolytes, and other analytes such as glucose. A user such as a subject or doctor uses an optical reader 420, such as the readers disclosed herein, to interrogate the sensors. In certain embodiments, fluorescent sensors

Additionally, the nanoparticles can be biocompatible to prevent an immune response. The response can be specific to the concentration of the molecule or ion being measured. The response can be quantitatively measurable by the portable electronic imaging device. Nanoparticles can be made using techniques disclosed in, e.g., U.S. Pat. Nos. 6,143,558, 6,379,955 B1 and US 2009/0142274 A1, each of which are herein incorporated by reference.

In certain embodiments, the fluorescent sensors are tattooed onto the subject. Such tattooing has been disclosed previously in U.S. Appl. Ser. No. 2009/0155183 A1, incorporated by reference herein. In such embodiments, the intra- and extra-cellular nanosensors reside under the skin, and the disclosed system, which comprises an optical reader can be used to interrogate the sensors as needed. Therefore, the disclosed system can allow patients and/or other healthcare professionals to measure the levels of one or more analytes (e.g, electrolytes such as sodium) at any point in the day and as frequently as desired. Popular, commercially available portable electronic devices with optical readers can be transformed into a diagnostic instrument that can also communicate with care providers and provide assistance in emergency cases.

Further embodiments entail providing or attaching fluorescent sensors into a well, such as on a multiwell plate, tubing, chip, membrane, or surface that contacts samples in which analytes are present. In these embodiments, the fluorescent sensors interact or bind to analytes. Subsequently, the fluorescent sensors that have interacted or bound to analytes will fluoresce when contacted with an excitation light. Thus, the fluorescent sensors can detect one or more analytes that have passed across a surface.

### 3. Description of Illustrative Embodiment

FIGS. 6a-6d show different views of an exemplary case according to aspects of the present disclosure. As described above, FIG. 6a depicts a front view of the case. The case 600 can have a lip 620 that holds the portable electronic device and a plate to cover a microprocessor/microcontroller 640. Additionally, a hole is defined for providing camera access to the optical chamber. FIG. 6b depicts the back view of the case 600 and shows the optical chamber 650 with a clear cover and possible connection capabilities of the case 600 to the portable electronic device utilizing a standard portable electronic device input/output (“I/O”), for example, a 30-pin dock 660. In certain embodiments, the wires from the 30-pin dock 660 are located entirely within the case 600. FIG. 6c depicts a side view of the case 600, which shows a possible contoured shape of the case. Finally, 6d depicts a bottom view of the case 600. FIG. 6d shows a cord 670 running from the 30-pin dock. The case 600 can be constructed such that wires from the portable electronic I/O port to a microcontroller housed on the case and from the microcontroller to the optical chamber can run within the case.

FIG. 7 shows a prototype case that was designed in Solidworks and was built using a stereolithography rapid prototyper. FIG. 7a shows a drawing of the case 700. In this embodiment, an optical chamber 710 is attached to the case 700 and covers the optical filter 730. As shown in FIG. 7A, the case 700 can have slots 720 for attachment to the portable electronic device. In these embodiments, the slots 720 are configured for the portable electronic device to slide into position in the case. FIG. 7B shows the back of the case 700, which houses the optics, a Arduino microcontroller 740, a push button 750 to control the LED lights, and a battery 760 (e.g., a 9V battery). In certain embodiments, the case 700 is constructed to fit onto an iPod Touch. It can be understood that the use of an iPod Touch is not limiting and that other portable electronic devices can be used. According to the particular embodiment, the optical chamber 770 contains surface mount (SMD) LEDs 780 that produce 476 nm excitation light, which excites the sensors. The light emitted from the sensors is collected through a longpass emission filter 790 by the built-in CMOS camera sensor on the iPod. The camera sensor is RGB, which splits the signal from the two fluorophores and enables ratiometric sensing. The image is exported and processed to determine target molecule concentration.

In specific embodiments, the prototype uses a battery and has a button controller for manual control of the excitation light. According to alternative embodiments, the case can be connected to the portable electronic device through the portable electronic device I/O for controlling the excitation light through software running on the phone. Additionally, the excitation light can be powered by the mobile device.

In the implementation shown in FIG. 7, the LEDs are controlled through an Arduino microcontroller which houses resistors and a push button activation. A 9V battery powers the system. An optical filter fits between the optical chamber and the case in front of the camera of the portable electronic device. In the prototype depicted in FIG. 7, the LEDs provide 476 nm wavelength light. It can be understood that LEDs emitting light in difference wavelengths can be used, as long as the sensors are excited and the excitation light is filtered out by the emission filter.

The prototype has an optical chamber that houses the emission filter and three LEDs to produce the excitation light. The chamber also creates a light-tight imaging area that can prevent outside light from being imaged by the camera. The LEDs were wired in parallel with individual resistors mounted to the bottom of a protoboard attached to the microcontroller.

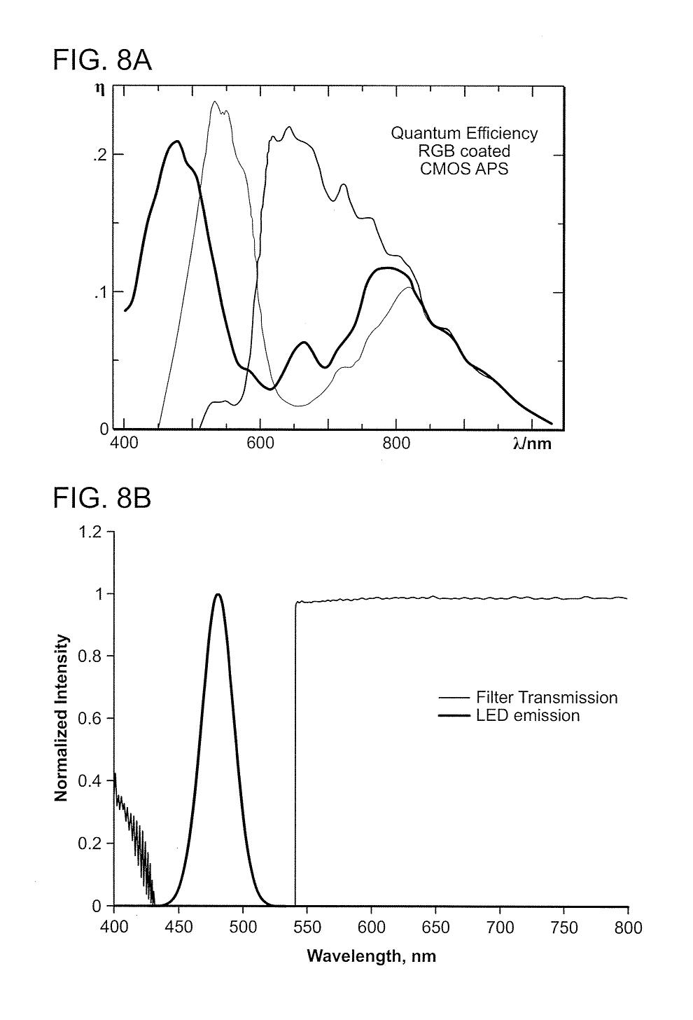

As shown in FIG. 7, the SMD LEDs 780 with a peak emission wavelength at 476 nm and a full width half maximum of about 30 nm were used to minimize the necessary space. The recent advances in LED technology have produced extremely bright, inexpensive LEDs. In a working embodiment, the LEDs were connected to 30 gauge copper wire with solder. Although 476 nm is not the peak absorbance wavelength of the sensors for excitation, as shown in FIG. 8a, the lower peak wavelength prevents bleed through of the red-tail excitation light through the emission filter. In the working embodiment, the LEDs were wired in parallel with individual 120 ohm resistors to dissipate power. This provides approximately 75 milliamps of current to each LED. The LED power can be controlled with a push button built into a protoshield connected to the microcontroller and an image can be taken through the existing camera software. A 532 nm long pass filter, shown in FIG. 8b was inserted between the sample and the iPod camera to prevent LED excitation light from being imaged by the iPod. The iPod uses an RGB CMOS sensor to take images. This splits the light into three channels, red, green and blue, as shown in FIG. 8a.

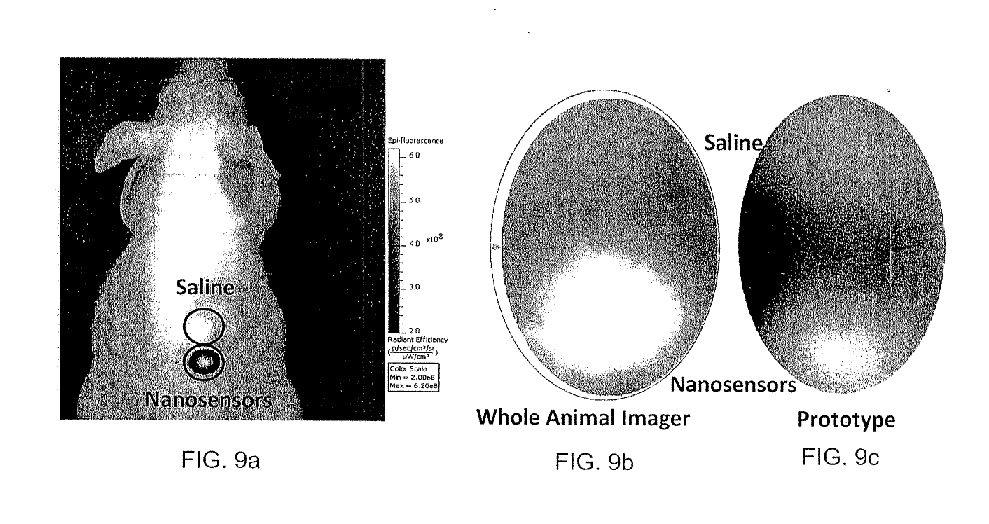

In some embodiments, whole animal imaging is performed. FIG. 9 shows the portable electronic device used in vivo on a nude mouse that had been intradermally injected with a solution containing nanosensors composed of the same sodium sensing material used in the microworm sensors and a saline injection to serve as a control. FIG. 9 shows images taken from a whole animal imager and the iPod prototype. FIG. 9a is a software optimized red wavelength signal showing the two injection spots. FIGS. 9b and 9c show the raw data images from the whole animal imager and the iPod prototype are shown. The image from the whole animal imager was obtained by exciting the sensors at 480 nm and collecting emission at 580 and 680 nm for the green and red channels. The image from the iPod prototype was obtained by exciting the sensors with the LEDs assigning the green and red channels of the built in RGB camera to red and green colors. There is some autofluorescence in the green channel, seen in the saline injection site, however the iPod prototype detects the fluorescence signal from the sensors.

In particular embodiments, the use of fluorescent sensors to monitor continuously analyte or cell concentrations in vivo allow patients who need to tightly monitor their concentrations to more accurately and comfortably do so. These sensors will not diffuse out of the injection site in the dermis of the skin, do not appear to cause an inflammatory response in vivo, and can continuously monitor concentrations through either a laboratory scale imager or a hand held device.

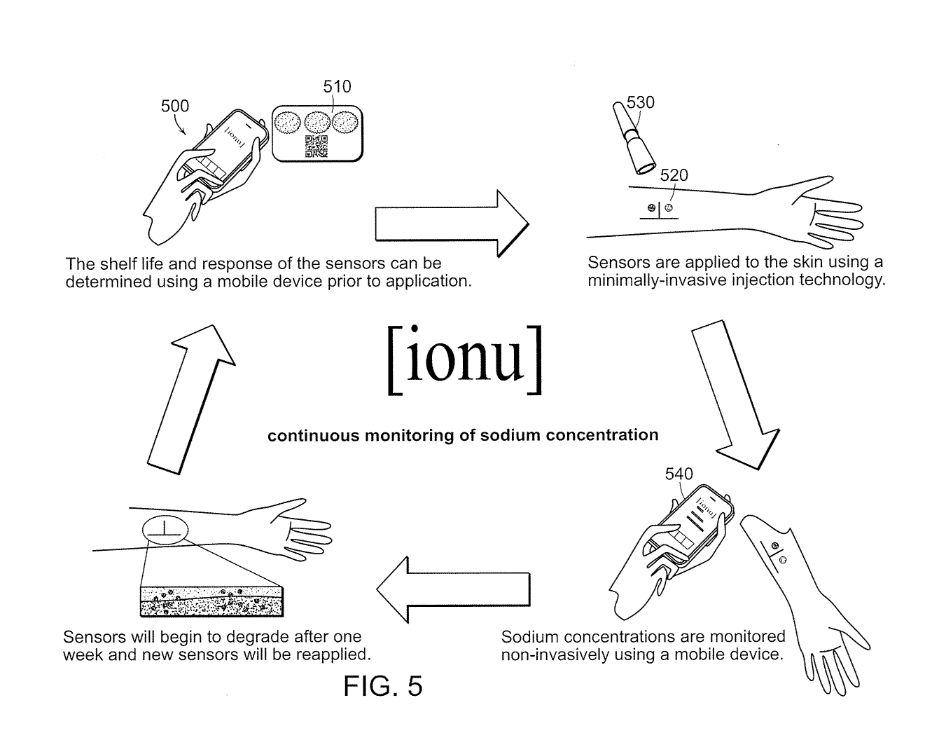

FIG. 5 shows an embodiment in which fluorescent sensors that react to one or more analytes are injected into the dermal space. FIG. 5 depicts such a method of using the disclosed system. A case is attached to the portable electronic device 500. The case can create the optical environment for the portable electronic device 500 to make diagnostic measurements. Prior to placing sensors into the skin, the shelf life of the sensors can be determined using the portable electronic device 500 to interrogate sensors located on packaging provided with the sensors. In FIG. 5, the three separate compartments 510 are used to calibrate the system. Two of the sensor spots (the left and right) contain analyte responsive sensors in solutions with two different, known sodium concentrations. The third (middle) sensor spot contains sensors that do not respond to analyte (reference sensors). These fluorescent sensors have all the components of the sodium responsive sensors except the analyte recognition element and will be used as a control for skin tone, discussed more below. After the quality of the sensors is confirmed, they are injected into the skin at a particular location 520 using an injection device 530. In certain embodiments, the technique used to inject the sensors is minimally invasive and the sensors are fluorescent sensors. The subject can then monitor analyte concentrations, such as sodium, over a period of hours, days, or weeks using a handheld system 540 disclosed herein. Such measurements can be performed using one or more LEDs located on the case (not shown) attached to the portable electronic device 500. In cases where fluorescent sensors are used, the LEDs provide excitation light to excite the fluorescent sensors. LEDs can also provide brightfield illumination. The disclosed system can further comprise an emission filter that can block the excitation light from reaching the portable electronic device 500 camera, allowing only fluorescent light to pass. The LEDs can be manually controlled or controlled through the phone, therefore reducing the complexity of the controlling environment of the diagnostic instrument. Therefore, the system essentially converts a standard portable electronic device into a fluorescence diagnostic device. In certain embodiments, the case is connected through a charging/data transfer port of the portable electronic device.

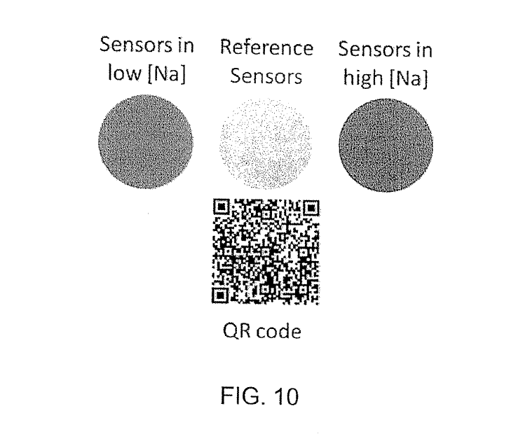

In certain embodiments, kits are also disclosed. The kits include sensors that are purchased and stored for months in a refrigerated environment in light-protective packaging. A light protective foil cover is include with the kit and is used to prevent photobleaching. The packaging is removed when the sensors are used. The packaging of the sensors enables functions that are crucial to create an easy to use, accurate detection system. The kits also include three separate compartments, some of which are similar to bubble packing, that contain three different sensors, as shown in FIG. 10. Also shown is a QR code. Taking a picture with a QR reader application will show the information in this particular code.

For exemplary purposes only, the procedure set forth in FIG. 5 is described in a specific application of the systems and methods disclosed herein. In this embodiment, sodium levels are monitored in patients. However, it should be noted that the procedure shown in FIG. 5 is equally applicable to the detection of any analyte or other substance of interest.

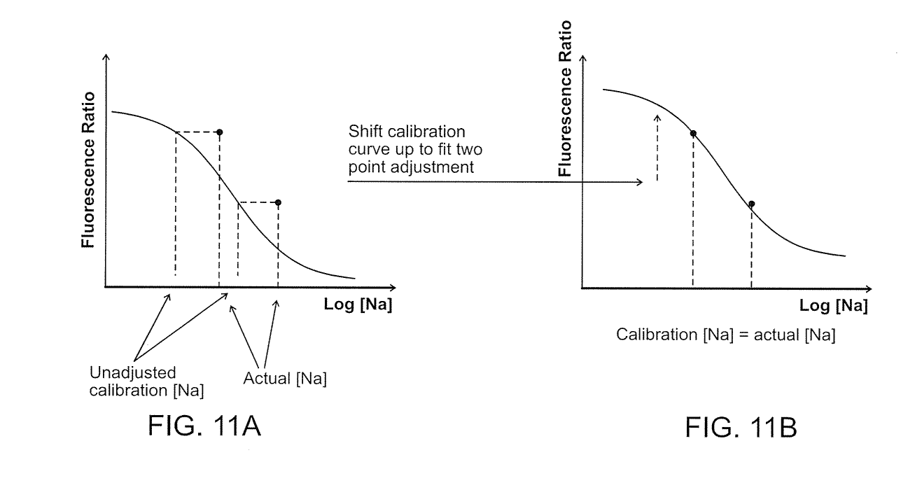

As noted above, the packaging can be fluorescent and can be used to calibrate the system by housing two compartments of sensors at known analyte concentrations. When a fluorescent image of the packaging is taken, the fluorescence intensity can be measured. Because the analyte concentration is known, and the calibration curve of this specific lot of sensors has been determined based on the QR code, the intensity measurement can be used to adjust the calibration curve to the particular electronic device. This is demonstrated in FIG. 11, where it is shown that making two measurements at known concentrations of analyte—in this case, sodium—(dots in FIG. 11a) can allow a software application stored on the processor of the portable electronic device to set the calibrated response to the correct fluorescence ration.

This approach will completely calibrate the sensors at each measurement point to eliminate drift in sensor functionality or other measurement artifacts. The intensities at each measurement will be recorded by the software application and significant deviations in intensity will alert the patient that something may be wrong. This added level of measurement validation will ensure the safety of the patient by preventing incorrect measurements.

This can eliminate inaccuracies in measurements that could occur from abnormalities of the imaging camera chip, exciting LEDs or emission filter. The fluorescent image of the sensors in the packaging can also be used to measure the fluorescence intensity of the reference sensors; this calibrates the skin of the patient. By taking an image of these sensors, both before and after injection, the software can determine how the skin alters the fluorescence. This known alteration of the fluorescence can then be used to determine the correct analyte concentration from the fluorescence of the analyte sensors. This can be performed using the following equations:

$$Z = \frac{{R}_{Packaging}^{Reference}}{{R}_{Injected}^{Reference}} , \\ {R}_{True}^{Na} = Z * {R}_{Measured}^{Na}$$

“Z” is a correction factor that is calculated by dividing the intensity “R” of the reference sensors in packaging by the value immediately after the sensors have been injected. The packaging value will be stored for the lifetime of the sensors and used to create a new “Z” at each reading. The true “R” of the sodium sensors will then be determined by multiplying “Z” by the measured “R” of the sodium sensors.

In medical diagnostic embodiments, the patient is provided with a kit comprising the fluorescent sensors and a light-protective cover (FIG. 5). After a light-protective cover has been removed the patient can take two images, one bright field and one fluorescent. The bright field image will allow the disclosed system to register the sensors by recognizing the QR code. A QR code is similar to a barcode and is an increasingly common way to relay information. The code will provide the lot number of the sensors which can be used to determine expiration date and calibrated response of the sensors. The sensor lot can be calibrated in the factory and this information can be transferred to the portable electronic device.

Furthermore, after the reference sensors are injected into the skin they will be imaged each time the sodium concentration is determined Therefore, at each measurement the correction factor obtained from the fluorescence of these sensors will be adjusted. This can remove error that may occur from sensor degradation, photobleaching, skin autofluorescence or other biological or physical artifacts when sodium concentration is measured.

After the patient has taken images of the packaging, the sensors will be injected into the intradermal space of the skin directly from the packaging (FIG. 5). One of the compartments containing analyte responsive sensors and the compartment containing the reference sensors will be injected. There are several minimally-invasive injection technologies that are FDA-approved and available on the market. These injection technologies are mainly designed for drug delivery devices or vaccine administration, but may be adapted for sensor delivery into the intradermal space. For example, in March 2011 the FDA cleared the first intradermal needleless injection system by PharmaJet® for vaccine delivery. These injection systems can delivery up to 100 μl of solution to the intradermal space using a high pressure system. Microneedle delivery systems can also be used to deliver sensors into the intradermal space without triggering the nerve fibers. After the two spots have been injected, a simple mark from a stamp in the packaging will indicate where the injections have been made as well as the orientation of the two spots.

Any time the patient wants to measure his or her analyte levels, the patient takes an image of the injection spot. This can provide an accurate measurement in real time that is pain free. After the sensors have been injected they can last for one week before they need to be replaced. At some point after a week, the sensors will begin to biodegrade and be removed naturally by the body. Removal can occur by renal elimination and sloughing off of sensor material when the dermis layer of the skin is replaced. To replace the sensors the patient simply uses a new package of sensors, takes the initial images, and injects the sensors in a different spot in their skin. There will be no permanent effects from the sensors so the same spot could eventually be used again.

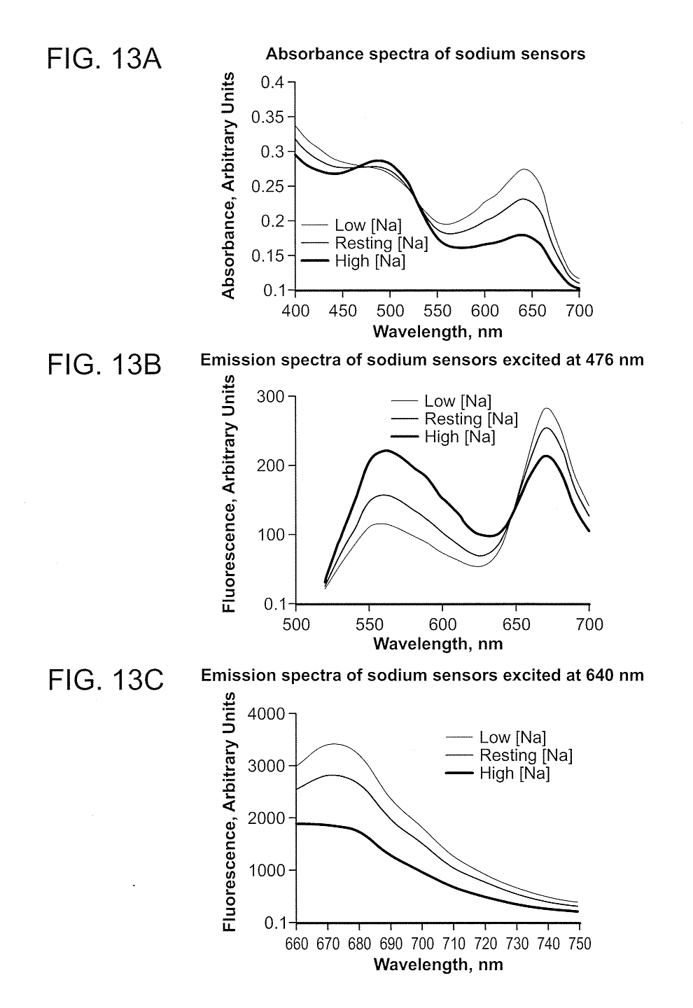

In the illustrative embodiment, the fluorescent sensors have multiple fluorescent excitation and emission wavelengths that can be used to determine fluorescent intensity. Exemplary embodiments are in FIG. 13, which provides data relating to the measurement of sodium concentrations. To achieve quantitative and accurate measurements, however, a ratio of two wavelengths must be used. This eliminates the dependency of the calculated sodium concentration on the number of sensors present, accounts for skin inhomogeneity, sensor injection depth, and possible photobleaching. Two emission wavelengths can be created by exciting the chromoionophore, for example, at 476 nm and collecting emission, for example, at the 570 nm and 670 nm peaks.

Traditionally, most in vivo imaging uses near-infrared dyes because of reduced absorbance and autofluorescence from tissue at wavelengths above 600 nm. Additionally, longer wavelengths of light will scatter less and penetrate deeper into tissue, increasing image resolution. However, since the sensors will be placed in the intradermal layer of skin, the penetration depth and tissue absorbance of excitation light is not a significant limitation because of the superficial location. Autofluorescence may contribute to fluorescence intensity measurements at wavelengths below 500 nm, but this limitation is not of great concern since the sensors are located in the upper layers of the skin. The prototype was designed to excite the sensors at 476 nm, which creates the necessary ratiometric measurements.

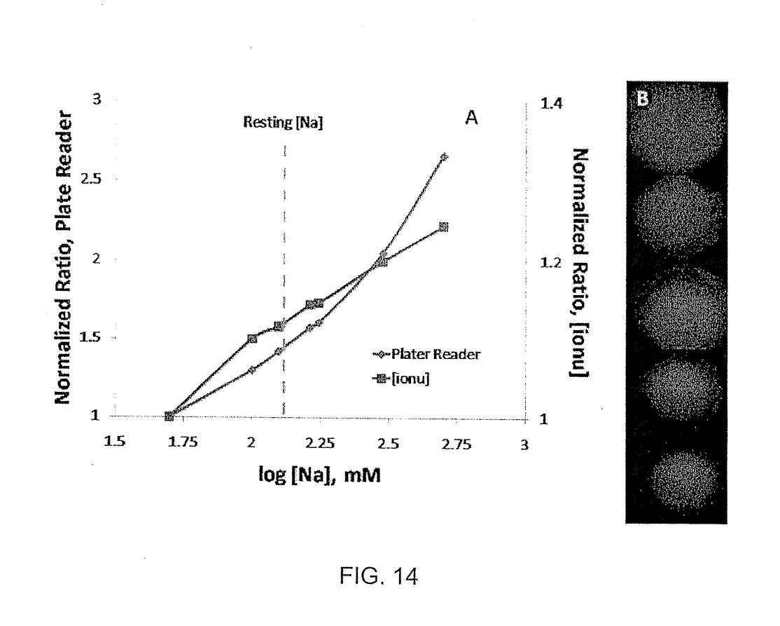

Sodium nanosensors were added to a 96 well plate containing solutions with varying sodium concentration. This allowed fluorescent intensity of sensors in different sodium concentrations to be measured. Fluorescence was measured in a microplate reader exciting the sensors at 476 nm and emission was collected at both 570 nm and 670 nm. The 570 nm intensity was divided by the 670 nm intensity to create a ratiometric measurement. Fluorescence was then measured with the iPod prototype by taking an image of each well in the 96 well plate. The images from the iPod prototype were exported and the RGB channels were separated. The intensity of the green channel was divided by the intensity of the red channel to create a ratio. These data were then plotted as a function of sodium concentration and compared to the results from the microplate reader, as shown in FIG. 14. The differences between the iPod and microplate measured response to sodium is largely due to collection of a larger bandpass of light in the iPod than in the microplate, in which the emission bandpass collection is tightly tuned. These preliminary data confirm the use of the disclosed system to detect changes in sodium concentration, however the sensors need to be optimized for the iPod optics to increase sensitivity.

### 4. Software Applications

All of the images can be recorded and interpreted by a software application running on the portable electronic. Furthermore, software can control the portable electronic device and operation of the system to measure fluorescence intensity.

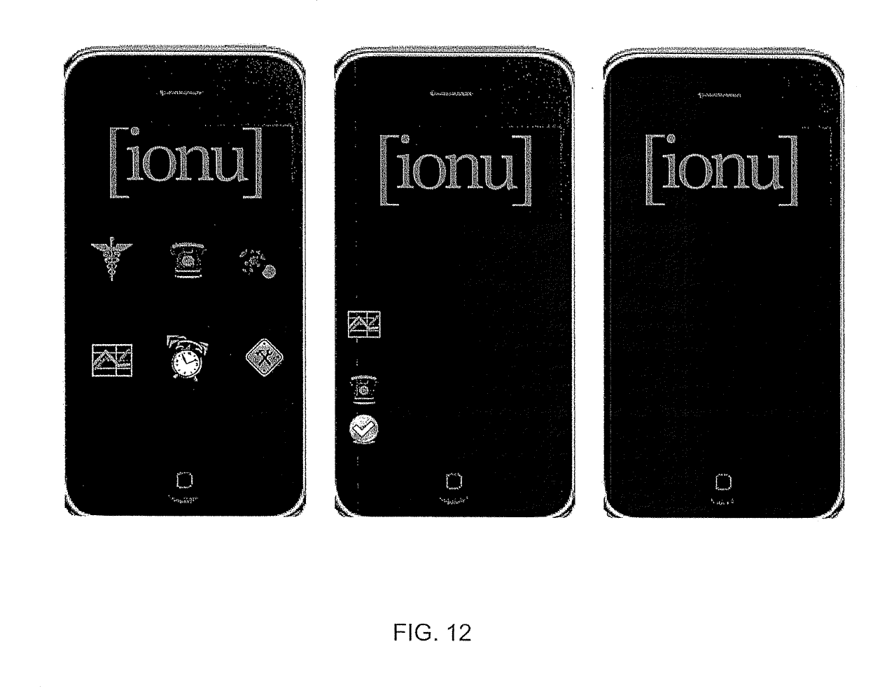

FIG. 12 shows an exemplary application interface. An exemplary “Main menu” is depicted on the left, an exemplary interface screen after a sodium measurement in the center, and an exemplary interface screen of an appropriate status update on the right.

This application can control the LEDs to illuminate while an image is taken. The software can then analyze the intensities of the image and calculate the concentrations of certain analytes using the shifted calibration curve that was obtained for the lot of sensors. This whole process can be controlled by the software and occur when a “measure” button has been selected. The software can record each measurement so that a history of such concentrations can be viewed.

The software application can take advantage of all the functions of portable electronic devices. The application will provide GPS information about where the patient is and where pharmacies or hospitals are on a map. For patients, additional software applications have an option to call for help in case of an emergency when certain analytes concentrations are at unhealthy levels. For certain medical applications, software will remind users when new sensors need to be applied.

The application software for the iPod can be developed with Xcode 4 from Apple. The application can control the LEDs for both brightfield and fluorescence imaging. The application can be programmed to split the images into red and green signal, define the regions of the image that contain the sensors and measure the average intensity of each the red and green signal in each region. The green intensity can then be divided by the red intensity and the ratio will be determined. The ratio can then be used in the calibration algorithm to determine the sodium concentration. This algorithm will have been determined with calibration data and Origin software and preloaded into the app software. Future versions of the app will allow the various features discussed in the approach section.

1. A method for performing fluorescent measurements using a portable electronic device, the method comprising:
providing at least one light emitting diode (“LED”) and an optical filter,
receiving an electrical stimulus at the at least one LED to activate the at least one LED;
emitting by the at least one LED an excitation light;
contacting one or more fluorescent sensors with the excitation light, the one or more fluorescent sensors emitting a fluorescent light when contacted with the excitation light; and
filtering by the optical filter such that a camera on the portable electronic device captures an image of the fluorescent light emitted from the fluorescent sensors.

2. The method according to claim 1 further comprising providing a microcontroller which provides the electrical stimulus to the at least one LED.

3. The method according to claim 1, wherein the fluorescent sensors comprise fluorescent dyes, chemical sensors, fluorescent proteins, nanoparticles, or combinations thereof.

4. The method according to claim 1, wherein the fluorescent sensors are detected in skin, fluid samples, blood, bodily fluids, tissue samples, hair, or immunoassays.

5. The method according to claim 1, wherein the at least one LED and the optical filter are located on a case adapted for attachment to the portable electronic device.

6. The method according to claim 5, wherein the case further comprises a microcontroller configured to provide the electrical stimulus to the at least one LED.

7. The method of claim 1 further comprising providing software to enable an interaction of the at least one LED, optical filter, and portable electronic device.

8. A device for enabling a portable electronic device to perform fluorescent measurements comprising a case adapted for attachment of the device to a portable electronic device, at least one light emitting diode, and an optical filter.

9. The device according to claim 8 further comprising a microcontroller.

10. The device according to claim 9, wherein the microcontroller is configured to operate the at least one LED.

11. The device according to claim 8, wherein the optical filter is positioned such that the filter covers a lens of a camera on the portable electronic device when the case is attached to the portable electronic device.

12. The device according to claim 8 further comprising a power source.

13. The device according to claim 8, wherein the case comprises an optical chamber adapted to be positioned over a camera on the portable electronic device, the optical chamber comprising the at least one LED and the optical filter.

14. A system for fluorescent measurement comprising a case comprising at least one light emitting diode (“LED”) and an optical filter, the case being attached to a portable electronic device comprising a camera, a processor, and an interface.

15. The system according to claim 14, wherein the processor comprises logic to enable a user to activate the at least one LED.

16. The system according to claim 14, wherein the processor comprises logic to enable the user to capture an image using the camera.

17. The system according to claim 16, wherein the image comprises a fluorescent emission from a plurality of fluorescent sensors.

18. The system according to claim 17, wherein the processor comprises logic to measure the intensity of the fluorescent emission from the plurality of fluorescent sensors.

19. The system according to claim 18, wherein the processor comprises logic to enable the user to calculate an amount of an analyte based on the intensity of the fluorescent emission.

20. The system according to claim 16, wherein the processor comprises logic to store the image in a memory on the portable electronic device.

21. The system according to claim 14, wherein the optical filter is positioned on the case to cover a lens on the portable electronic device.

22. The system according to claim 21, wherein the case further comprises a microcontroller.

23. The system according to claim 22, wherein the microcontroller is configured to operate the at least one LED.

24. The system according to claim 14, wherein the case comprises an optical chamber positioned over the camera on the portable electronic device, the optical chamber comprising the at least one LED and the optical filter.

25. The system according to claim 14, wherein the processor comprises logic to wirelessly transmit an image and related information to another portable electronic device.
